(19) United States
(12) Patent Application Publication
(10) Pub. No.: US 2011/0238516 A1
(43) Pub. Date: Sep. 29, 2011

(54) E-COMMERCE THREAT DETECTION

(75) Inventor: Paul McAfee, Florissant, MO (US)

(73) Assignee: SECUREFRAUD INC., St. Louis, MO (US)

(21) Appl. No.: 12/732,808

(22) Filed: Mar. 26, 2010

(51) Int. Cl. G06Q 99/00; G06Q 30/00

(52) U.S. Cl. 705/26.1; 705/325

(57) ABSTRACT

Systems and methods of e-commerce threat detection are provided. The method detects fraud, fraudsters, theft rings, and stolen merchandise for sale on various e-commerce platforms. The method begins by receiving a user query relating to the activities associated with an individual or item; compiling data provided on one or more web site relating to the individual or item; determining a probability of fraudulent activities associated with an individual or item; displaying the probability of fraudulent activities to the user; and providing for user customization of the displayed material.

### REFERENCE TO RELATED APPLICATION

Not applicable.

### BACKGROUND OF THE INVENTION

1. Field of the Invention

Aspects of the disclosure relate to systems and methods of e-commerce threat detection. More particularly, aspects of the disclosure describe systems and methods for detecting fraud, fraudsters, fraud rings and stolen merchandise on the Internet.

2. Background

Computer networks, specifically the Internet, have become a central and lively place for conducting business. Many financial transactions are conducted on the Internet and large quantities of merchandise exchanges hands. Conducting business and selling merchandise has become very common and communication between people and entities has been streamlined as a result of the advancements in communications technology, such as the Internet.

Almost as quickly as the Internet developed, fraudsters began preying on users and consumers. Fraudsters capitalized on the opportunity to take advantage of businesses and individuals by stealing merchandise and selling it on the Internet or duping individuals into purchasing products that have been stolen or do not exist. For example, fraudsters can create user accounts on web sites such as Craigslist, Ebay, and Amazon to sell stolen merchandise to consumers.

Many fraudulent activities carry criminal and civil punishments in most countries. Furthermore, some individuals refrain from using online services due to the risk of the coming into contact with fraudsters and stolen property. In response to an increasing demand from businesses, consumers and users of the internet, many entities offer online services that attempt to streamline the customer's and user's experience in transacting business. However, fraudsters target specific industries and web sites and understand the process of overcoming the boundaries of the streamlined process. For example, fraudsters that implement fraud rings or attempt to sell stolen property may create one or more accounts on an online auction web site such as Ebay. Once a fraud ring has been implemented, a fraudster can then initiate the sale of stolen property via the one or more accounts. Ebay, for example, provides for feedback ratings of its users which indicate a level of trust associated with the seller of merchandise. Fraudsters use this feedback to their advantage through the utilization of the one or more accounts in their possession. Therefore, a method of detecting fraud is needed that is capable of identifying fraud, fraudsters and assist in the prevention of fraud.

### SUMMARY OF THE INVENTION

Aspects of the present disclosure address one or more of the issues mentioned above by describing systems and methods for e-commerce threat detection, detecting fraud, preventing fraudster rings, and locating stolen property. The following presents a simplified summary of the invention in order to provide a basic understanding of some aspects of the invention. This summary is not an extensive overview of the invention. Its sole purpose is to present some concepts of the invention in a simplified form as a prelude to the more detailed description that is presented later.

In one aspect of the invention, a method of detecting fraud can comprise: (a) receiving a user query relating to information associated with at least one of an individual and an item; (b) compiling one or more attributes provided on one or more web sites relating to at least one of the user query, the individual and the item; (c) determining a probability of fraud associated with at least one of the user query, the individual and the item; and (d) displaying information relating to the probability of fraud to the user.

In another aspect of the invention, a system for detecting fraud can comprise: (a) a computing device comprising memory for storing data in a data file, the memory storing a plurality of components comprising computer-executable instructions, the plurality of components including: (b) a receiving component for receiving a query relating to at least one of an individual and an item; (c) an attribute database component for obtaining and storing one or more attributes relating to at least one of one or more individuals, items, and the correlations thereof; and (d) an application server component for analyzing the correlations between the query and the attributes.

In an additional aspect, a computer-readable medium can comprise computer-executable instructions to perform a method that comprises: (a) receiving a user query relating to information associated with at least one of an individual and an item; (b) compiling attributes provided on one or more web sites relating to at least one of the individual and the item; (c) determining a probability of fraudulent activities associated with at least one of the individual and the item; (d) altering the user of fraudulent activities; and (e) displaying information relating to the probability of fraudulent activities to the user.

In addition, while a particular feature of the invention may have been disclosed with respect to only one of several implementations, such feature may be combined with one or more other features of the other implementations as may be desired and advantageous for any given or particular application.

### BRIEF DESCRIPTION OF THE SEVERAL VIEWS OF THE DRAWINGS

FIG. 1 illustrates a computing system in accordance with an aspect of the invention.

FIG. 2 illustrates a method of detecting fraud, in accordance with an aspect of the invention.

FIG. 3 illustrates prior sales attributes in accordance with an aspect of the invention.

FIG. 4 illustrates USERID and feedback attributes in accordance with an aspect of the invention.

FIG. 5 illustrates merchandise attributes in accordance with an aspect of the invention.

FIG. 6 illustrates a method of detecting fraud, in accordance with another aspect of the invention.

FIG. 7 illustrates a user interface in accordance with an aspect of the invention

FIG. 8 illustrates a flow chart in accordance with an aspect of the invention.

FIG. 9 illustrates a flow chart in accordance with another aspect of the invention.

### DETAILED DESCRIPTION

The forgoing as well as other aspects and advantages of the invention will become apparent from the following detailed description when considered in conjunction with the accompanying drawings and other material, wherein like reference characters designate like parts throughout the several views. In the following description, for purposes of explanation, numerous specific details are set forth in order to provide a thorough understanding of the subject invention. It may be evident, however, that the invention can be practiced without these specific details. It should also be appreciated that although specific examples presented may describe or depict certain aspects of the subject invention, the invention is not limited to those aspects. Those of ordinary skill in the art will readily recognize that the disclosed invention can be used for other purposes and in other manners other than those described.

As used herein, the term “fraud” refers to, but is not limited to, its normal defined meaning, any deceit, trickery, intentional perversion of the truth in order to induce another to part with something of value or to surrender a legal right, intentional perversion of the truth in order to induce another to purchase a stolen article, an act of deceiving or misrepresenting, trick, imposter, one who defrauds, cheat, deception, a fraud ring, fraudster, stolen merchandise, theft patterns, crimes, trends, stolen property and the like.

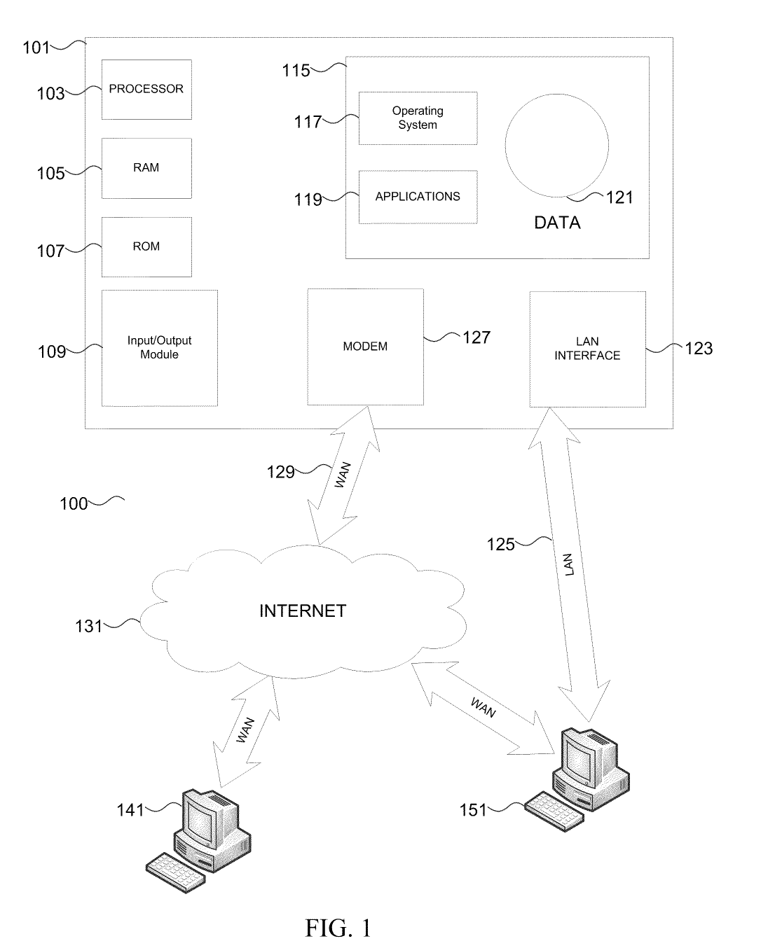

The system and method of detecting fraud can be embodied in a computing system environment. FIG. 1 illustrates an example of a computing system environment 100 that can be used according to one or more embodiments of the invention. The computing system environment 100 is only one example of a suitable computing environment and is not intended to suggest any limitation as to the scope of use or functionality of the invention. The computing system environment 100 should not be interpreted as having any dependency or requirement relating to any one or combination of the illustrated components.

The invention is operational with numerous other general purpose or special purpose computing system environments or configurations. Examples of well known computing systems, environments, and/or configurations that can be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention can be described in the general context of computer executable instructions, such as program modules, or program components, being executed by a computer. Program modules or components include routines, programs, objects, components, data structures, etc. that perform particular tasks or implement particular abstract data types. The invention can also be practiced in distributed computing environments where tasks are performed by remote processing devices that are linked through a communications network. In a distributed computing environment, program modules or components can be located in both local and remote computer storage media including memory storage devices.

With reference to FIG. 1, the computing system environment 100 can include a computer 101 having a processor 103 for controlling overall operation of the computer 101 and its associated components, including RAM 105, ROM 107, an input/output module or BIOS 109, and a memory 115. The computer 101 typically includes a variety of computer readable media. The computer readable media can be any available media that can be accessed by the computer 101 and can include both volatile and nonvolatile media and removable and non-removable media. By way of example, and not limitation, computer readable media can comprise computer storage media and communication media.

Computer storage media can include volatile and nonvolatile and removable and non-removable media implemented in any method or technology for storage of information such as computer readable instructions, data structures, program modules, or other data. Computer storage media includes, but is not limited to, random access memory (RAM), read only memory (ROM), electronically erasable programmable read only memory (EEPROM), flash memory or other memory technology, CD-ROM, digital versatile disks (DVD) or other optical disk storage, magnetic cassettes, magnetic tape, magnetic disk storage or other magnetic storage devices, and any other medium that can be used to store the desired information and that can be accessed by the computer 101.

Communication media can embody computer readable instructions, data structures, program modules, program components, and/or other data in a modulated data signal such as a carrier wave or other transport mechanism. It can also include any information delivery media. A modulated data signal is a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer readable media. Although not shown, RAM 105 can include one or more applications representing the application data stored in RAM 105 while the computer is on and corresponding software applications (e.g., software tasks) are being executed.

The input/output module or BIOS 109 can include a microphone, keypad, touch screen, and/or stylus through which a user of the computer 101 can provide input. The input/output module or BIOS 109 can also include one or more of a speaker for providing audio output and a video display device for providing textual, audiovisual, and/or graphical output.

Software can be stored within memory 115 to provide instructions to the processor 103 for enabling the computer 101 to perform various functions. For example, the memory 115 can store software used by the computer 101, such as an operating system 117, applications 119, and an associated data file 121. Alternatively, some or all of the computer executable instructions for the computer 101 can be embodied in hardware or firmware (not shown). As described in detail below, the data file 121 can provide centralized storage of data.

The computer 101 can operate in a networked environment that supports connections to one or more remote computers, such as computing devices 141 and 151. The computing devices 141 and 151 can be personal computers or servers that include many or all of the elements described above relative to the computer 101. The network connections depicted in FIG. 1 can include a local area network (LAN) 125 and a wide area network (WAN) 129 and can also include other networks. The computer 101 is connected to the LAN 125 through a network interface or adapter 123. The computer 101 can be a server and can include a modem 127 or other means for establishing communications over the WAN 129. For example, the computer 101 can connect to a WAN 129 such as the Internet 131 through a modem connection. The network connections can include any communications link between computers.

The existence of any of various well-known protocols such as TCP/IP, Ethernet, FTP, HTTP, and the like is presumed, and the system can be operated in a client-server configuration to permit a user to retrieve web pages from a web-based server. Any of various conventional web browsers can be used to display and manipulate data on web pages.

Additionally, an application program can be used by the computer 101 according to an embodiment of the invention. The application program can include computer executable instructions for invoking user functionality related to communication, such as email, short message service (SMS), and voice input and speech recognition applications.

The computing devices 141 or 151 can also be mobile terminals including various other components, such as a battery, speaker, and antennas (not shown). The input/output module or BIOS 109 can include a user interface including such physical components as a voice interface, one or more arrow keys, joystick, data glove, mouse, roller ball, touch screen, or the like.

Each of the plurality of computing devices 101, 141, 151 can contain software for creating a data file 121. The software can be a set of detailed computer-executable instructions for the computing devices 101, 141, 151. The software can provide the computing devices 101, 141, 151 with the ability to create a data file 121. The data file 121 can contain multiple individual files of information. For example, a plurality of inventory or attributes can be managed and information relating to each inventory or attribute can be received onto a computer network. The information relating to each inventory or attribute can be separately contained in a unique data file 121. One or more of the data files relating to a plurality of inventories or attributes can be coupled to each other in any suitable fashion.

The computer 101 can include memory 115 for storing computer-readable instructions and a processor 103 for executing the computer-executable instructions. The computer-executable instructions can be data in the form of program source code that can be capable of modifying the data file 121. The computer-executable instructions can be a series or sequence of instructions for a computing device that is typically in the form of a programming language such as C++, Java, SQL, or the like. Various computer programming languages can be used to create the computer-executable instructions, and the invention is not limited to the programming languages listed above.

The memory 115 can be a portion of the computer 101 that stores data or other instructions. The memory 115 can be retained or lost when power is lost to the system. The memory 115 can provide access to data for a user or computing device 141, 151 to revise and manage a data file 121.

The processor 103 can be capable of executing the computer-executable instructions. The computer-executable instructions can be executed by the processor 103 after they have been stored in the memory 115. The processor 103 can be a centralized element within a computing system that is capable of performing computations. For example, the processor 103 can perform the computations that are described in the computer-executable instructions and then execute the computer-executable instructions. The computer-executable instructions can include data describing changes to the data file 121 that were made by a user or computing device 141, 151 over a computer network such as the Internet 131. The computer 101 stores the data in the data file 121 that can be associated with aspects of the invention. The data file 121 can be stored in the memory 115 so that it can be accessible to a plurality of computing devices 141, 151 and/or users.

Data relating to aspects of the invention can be stored in data file 121. Security precautions can be implemented to prevent unauthorized access to the data file 121. User identification and a password can be required to access the data file 121 and/or the data relating to aspects of the invention. Some of the data that is stored in the data file 121 can be shared between multiple data files. Any desirable security precautions can be implemented.

The computer-executable instructions can be a series or sequence of instructions for a computing device 101, 141, 151, described in detail throughout this disclosure. The processor 103 can be configured to execute the computer-executable instructions that can be used to detect e-commerce fraud, fraudsters, fraud rings or stolen merchandise. Such computer-executable instructions can be located (e.g., physically or logically) in modules or components in the memory 115. The computer network 131 can be any network that interconnects users and/or computing devices 101, 141, 151. According to at least one aspect of the invention, the computer network 131 can provide shared access by two computing devices to at least a portion of the data in the plurality of modules or components. Shared access can be two or more computing devices 101, 141, 151 that can be coupled to the computer network 131 and/or that can be able to communicate with each other and/or access, change, and add data to a data file 121.

A computer network such as the Internet 131 provides access to the date file 121 that can be shared between the computing devices 101, 141, 151. Additionally, the computer network can be public or private and can be wired or wireless. The computing devices 101, 141, 151 that are coupled to the computer network can be any electronic device that is capable of connecting to a computer network and transmitting or receiving data over the computer network. Further, the computing devices are capable of receiving data for entry into a data file 121 that can be associated with aspects of the invention. Aspects of the invention can be utilized through a computer-readable medium, a web site, an application, a server, or any other means of providing a user with e-commerce threat detection.

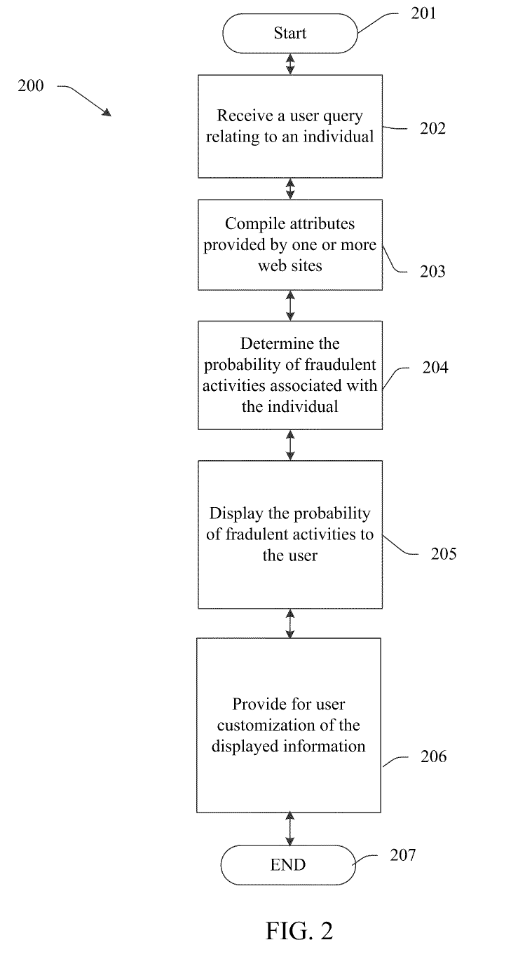

FIG. 2 illustrates a method of detecting fraud, in accordance with an aspect of the invention. Said method can be embodied on a computer-readable medium and be utilized on one or more computing devices or networks. The method of detecting fraud comprises: (a) receiving a user query relating to information associated with an individual; (b) compiling one or more attributes provided on one or more web sites relating to the individual; (c) determining a probability of fraudulent activities associated with the individual; (d) displaying information relating to the probability of fraudulent activities to the user; and (e) providing for user customization of the displayed information.

The method, represented generally at 200, begins at step 201, thereafter at step 202 a user query is received via a user interface (e.g. Java applet) relating to the activities associated with an individual. At 203 attributes associated with the individual are compiled. For example, a web crawler can be utilized to parse data/attributes over one or more web sites, including one or more e-commerce web sites or platforms. In the example of detecting fraudulent activity on an auction-based web site, the attributes that are compiled and stored can include, but are not limited to, attributes relating to an individual (e.g. an individual's prior and/or current sales history, an individual's feedback) and the information relating to the merchandise involved in the current or prior sales of the individual or others. At 204 the probability of the individual being involved in fraudulent activity is determined. At 205 the probability of the occurrence of fraud is presented to the user. At 206 the user can customize the information displayed and the method ends at 207.

Attributes are compiled via one or more API's, web crawlers, and/or smart crawlers. It is envisioned that any routine, protocol, application, program or software that can gather attributes, information, or data is envisioned as being within the scope of the invention. In an aspect, the crawlers utilize a user query to parse attributes contained on one or more web sites to assist in the identification of fraud, stolen merchandise, fraudsters and fraud rings. The crawler can be programmed in Java; however, other languages are envisioned as within the scope of the invention. Furthermore, the attributes compiled and other aspects of the invention can be stored in one or more storage mediums, or be provided to a user in real-time.

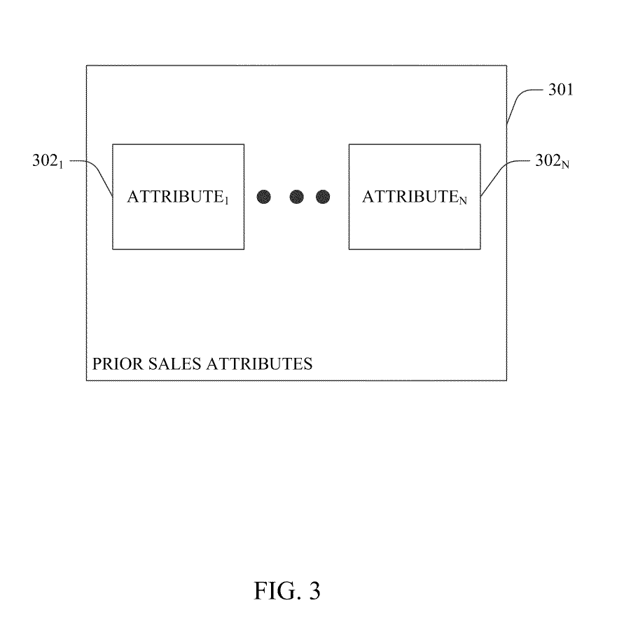

FIG. 3 illustrates prior sales attributes that can be utilized in determining if an individual is a fraudster, if an item for sale is stolen, or if a fraud is occurring, represented generally at 301. The one more attributes 302₁₋ₙ can include, but are not limited, the ID# of the item or items being sold, the ID# of the item or items that have been sold, item IDs, item title, the length of time associated with prior sales, date of transaction, date the item was listed, auction start time, date item closed, bid history, individuals associated with bid history, duration of the auction, item location, start price, model/product number, brand name, product line, model, transaction amount, transaction title, buyer location, buyer score, time bought, transaction ID, transaction title, transaction date, date listed transaction ended, transaction duration, score, time, the auction format utilized when selling merchandise, the number items sold below cost, bid activity, bid retraction, the amount the items were sold for, the type of items sold, median prices of all like items, standard deviation of like items, median of one or more attribute, standard deviation of one or more attribute, standard deviation of all sellers of like items, and the standard deviation and median of the merchandise being sold as compared to other sellers. These attributes can be related to a specific product, product type, an individual, or an individual's prior and current sales history. In addition, these attributes can be determined in specific time frames. For example, these time frames can include, but are not limited to, the standard deviation and median prices of items sold and/or bought within one or more time frames. The time frames can represent any amount of time. For example, seconds, minutes, hours, days, weeks, months and years. In an aspect, attributes can be compiled and medians and standard deviations can be computed for an individual's items sold or items bought within the first 15 or 30 days or last 15 or 30 days on one or more web sites.

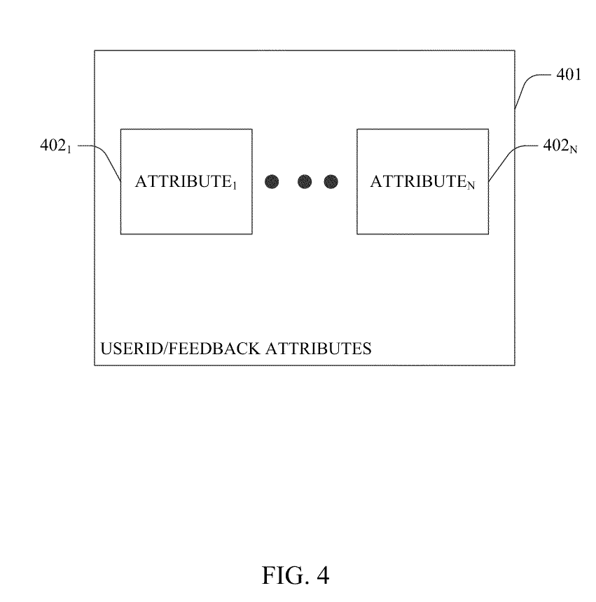

FIG. 4, illustrates USERID/feedback attributes that can be utilized in determining if an individual is a fraudster, if an item for sale is stolen, or if a fraud is occurring, represented generally at 401. The one or more attributes 402₁₋ₙ can include, but are not limited to, an individual's seller ID, an individual's user profile or attributes associated thereto, user ID, username, date joined, location, feedback id, registration date, past transactions, current transactions, rating, type of dealer, dealer user ID, feedback score, registration location, registration status, feedback data, feedback date, information relating to the individuals who left feedback for the individual, the number transactions between one or more individuals, and the type of transactions between one or more individuals. In an aspect, one or more accounts can be analyzed for an individual.

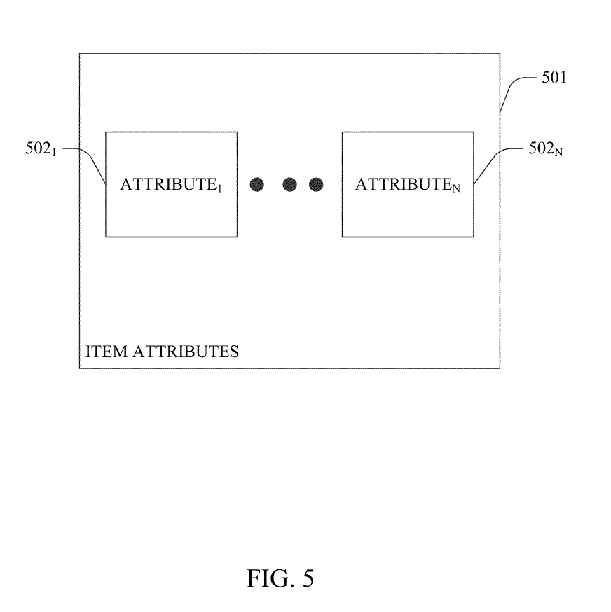

FIG. 5, illustrates item attributes that can be utilized in determining if an individual is a fraudster, if an item for sale is stolen, or if a fraud is occurring, represented generally at 501. The one or more attributes 502-502₁₋ₙ can include, but are not limited to, the product title, ISBN, UPC, ASIN, cost, retail, list price, sales price, location, inventory loss date, quantity, model/product number, brand name, product line, one or more inventory list, one or more inventory adjustments and model.

An example of detecting fraud on an online auction-based web site will be used throughout this disclosure. However, it is to be understood that other applications of the systems and methods disclosed herein are envisioned as within the scope of the invention.

In an online auction-based web site, such as Ebay, generally honest users interact with other honest users, while fraudsters will interact in small cliques of their own to mutually boost their credibility. Using the example of Ebay, credibility can be boosted through the user's feedback rating and the number of sales completed. Fraudsters create two types of identities/profiles and arbitrarily split them into two categories—fraud and accomplice. The fraud identities/profiles are used to carry out the actual fraud, while the accomplices exist only to help the fraudsters carry out their job by boosting feedback ratings. Accomplices themselves behave like perfectly legitimate users and interact with other honest users to achieve high feedback ratings. On the other hand, they also interact with the fraud identities to form near bipartite cores, which help the fraud identities gain a high feedback rating. Once the fraud is carried out, the fraud identities get voided by the auction site, but the accomplice identities linger and can be reused to facilitate the next fraud.

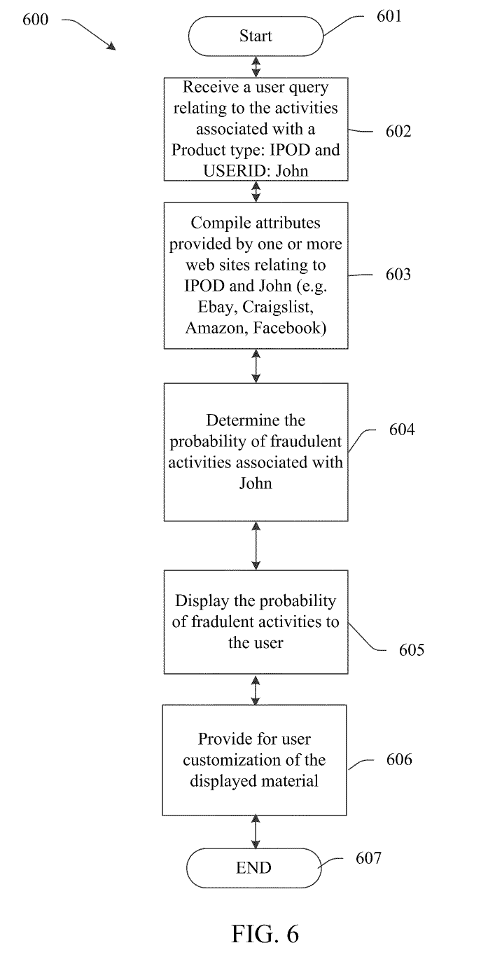

FIG. 6 illustrates an example of a user interaction with aspects of the systems and methods described herein. In this example, a user is attempting to identify individuals selling stolen IPODs on Ebay and determining if said individuals are fraudsters. To do so, the user queries the system with information relating an individual's user name or product type on Ebay at step 602. In this instance, we will use the example of the product type: IPOD, associated with a seller USERID: John. The system receives the query via a Java applet, but other alternatives are envisioned. For example, DHTML, Flash, Microsoft Silverlight and Viewpoint Media Player.

The query is sent to an application server which is in communication with a data master (storage device) each of which can maintain a centralized repository of compiled fraudster or item data/attributes. The compiled data/attributes are obtained via one or more APIs and/or crawler agents that analyze auction/e-commerce user information attributes, as described in FIGS. 3, 4, and 5 and store these attributes in a MySQL database, step 603. However, it is envisioned that other databases are within the scope of the invention.

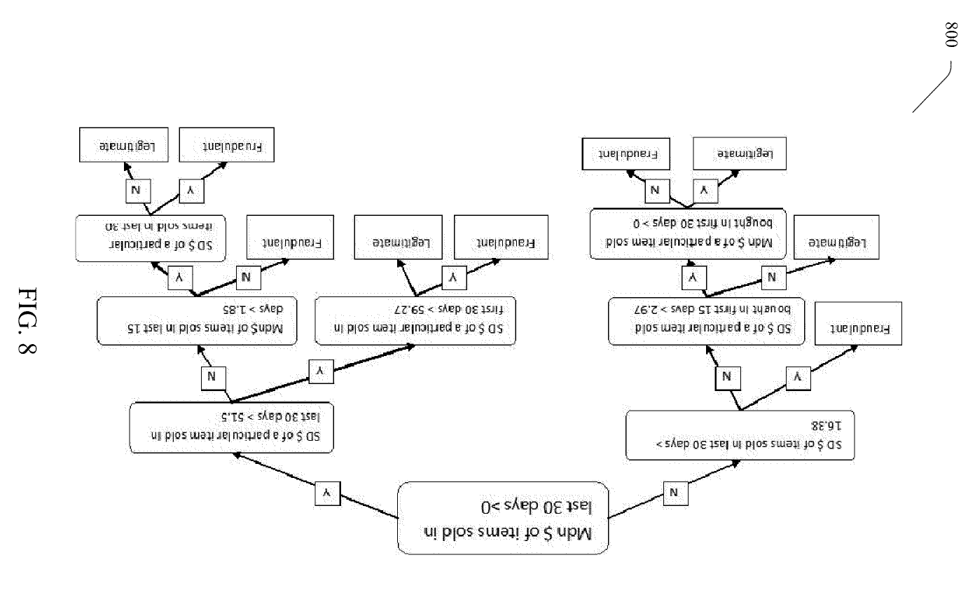

Attributes associated with the prior sales history of IPODs can be parsed. For example, a user can query specific instances of IPODs in a specific location or locations that have sold, utilizing the attributes that have been compiled via crawler application, as described in FIG. 3. The compiled attributes of IPOD can be compared with other like items that have been sold by this seller and or other like sellers. For example, the median prices, standard deviations of all like items, standard deviation of all sellers of like items, can be determined, analyzed and compared with like product sales, as well as all other attributes. Each listed attribute can be administered, manipulated, or customized by a user to provide specific results and comparison with an items sales history or current sales and/or John's sales history or current sales. An example of process flow, fraudulent determination, and user customization is provided in FIG. 8, represented generally at 800. User customization can be accomplished at each point or block in the referenced drawing. For example, the median or standard deviation, dollar amount, and time span can be user customized. In addition, the results can be graphed so that the user can compare like auctions from other sellers.

In addition to analyzing a product's prior sales attributes, aspects of the invention can be utilized to parse attributes associated with USERID/Feedback of the individual being investigated, as described in FIG. 4. For example, attributes associated with USERID/Feedback of John can be compiled and analyzed through belief propagation.

Belief propagation can be utilized, such as Bayesian networks and Markov Random Fields (MRF). However, examples provided herein will utilize a MRF. Belief propagation is an algorithm used to infer the maximum likelihood state probabilities of nodes in a MRF. Belief propagation functions via iterative message passing between nodes in a network. A node in the MRF represents a user, while an edge between two nodes can denote that the corresponding users have transacted at least once. Each node can be in any of 3 states—fraud, accomplice, and honest. To completely define the MRF, a propagation matrix can be instantiated. This instantiation is based on the following intuition: a fraudster tends to heavily link to accomplices but avoids other honest nodes as well as accomplices (since an accomplice effectively appears to be honest to the innocent user.)

Transactions between individuals can be modeled as a graph and provided to a user, with a node for each user and an edge for one or more transactions between two users. As is the case with hyper-links on the Web an edge between two nodes in an auction network can be assigned a definite semantics, and can be used to propagate properties from one node to its neighbors. For instance, an edge can be interpreted as an indication of similarity in behavior—honest users will interact more often with other honest users, while fraudsters will interact in small cliques of their own (to mutually boost their credibility). Under this semantics, honesty/fraud can be propagated across edges and consequently, fraudsters can be detected by identifying relatively small and densely connected subgraphs (near cliques).

In deployment the underlying graph corresponding to transactions between auction site users, would be extremely dynamic in nature, with new nodes (i.e., users) and edges (i.e., transactions) being added frequently. In such a setting, if one expects an exact answer from the system, the system would have to propagate beliefs over the entire graph for every new node/edge that gets added to the graph. This would be infeasible in systems with large graphs, and especially for online auction sites where users expect interactive response times. To avoid wasteful recomputation of node beliefs from scratch, a mechanism to incrementally update beliefs of nodes upon small changes in the graph structure can be utilized. Therefore, the addition of a new edge will result in minor changes in the immediate neighborhood of the edge, while the effect will not be strong enough to propagate to the rest of the graph. Whenever a new edge gets added to the graph, the system proceeds by performing a breadth-first search of the graph from one of the end points of the new edge, up to a fixed number of hops, so as to retrieve a small subgraph, which can be referred to as the h-vicinity of n. Then belief propagation is performed only over the h-vicinity where while passing messages between nodes, beliefs of the nodes on the boundary of the h-vicinity are kept fixed to their original values. This can ensure that the belief propagation takes into account the global properties of the graph, in addition to the local properties of the h-vicinity.

An example algorithm is provided:

Symbol Definition

S set of possible states

bi(_) belief of node i in state _{—}

(i, j) (i, j)th entry of the Propagation Matrix

mij message sent by node i to node j

Table 1: Symbols and definitions

For any vector v, v(k) denotes its kth component. The set of possible states a node can be in is represented by S. For a node n, the probability of n being in state _{—} is called the belief of n in state _, and is denoted by bn(_).Belief propagation functions via iterative message passing between nodes in the network. Let mij denote the message that node i passes to node j.mij represents i's opinion about the belief of j. At every iteration each node i computes its belief based on messages received from its neighbors, and uses the propagation matrix to transform its belief into messages for its neighbors. Mathematically,

mij(_) X

_{—}0

(_{—}0,_) Y

n2N(i)\j

mni(_{—}0) (1)

bi(_) k Y

j2N(i)

mji(_) (2)

where mij is the message vector sent by node i to j N(i) is the set of nodes neighboring I k is a normalization constant starting with a suitable prior on the beliefs of the nodes, belief propagation proceeds by iteratively passing messages between nodes based on previous beliefs, and updating beliefs based on the passed messages. The iteration is stopped when the beliefs converge (within some threshold), or a maximum limit for the number of iterations is exceeded.

In addition to the utilization of the USERID/Feedback attributes, attributes associated with John's items that are for sale, or that have been sold can be parsed. For example, a user can query specific merchandise that John has for sale or has sold, utilizing the attributes of John that have been compiled via crawler application, as described in FIG. 5. In an aspect, a user can input an item's information, or attributes associated thereto, as illustrated in FIG. 5, or can upload an inventory list providing the system with a list of stolen items. These attributes can be compiled, compared and integrated with other parsed data/attributes. Therefore, a user can input one or more USERIDs, merchandise information, inventory adjustments, and/or inventory list and determine if an individual is a fraudster, is involved in a fraud or fraud ring, or is selling stolen merchandise. A user can continuously be in communication with aspects of the invention to provide real-time inventory adjustments and be provided with fraudulent activity updates allowing for real-time fraud alerts. Such fraud alerts can be provided through an email, text, phone call, voice mail, sound, light, fax or other indication.

In an example, a point value can be associated to any item attribute described herein or a statistical value thereof. Any calculation, including but not limited to, statistical calculation, summation, or variation thereof, is envisioned as being within the scope of the invention. For example, the title, UPC, ISBN, location, inventor loss date, cost, retail cost, quantity, or standard deviations thereof, can be assigned with a point value which can be summed to rank ordered results. Furthermore, correlation values can be associated with any attribute to determine the probability of fraudulent activities as described herein.

Once the attributes are compiled and stored in the application server or the data master, 603, the application server runs one or more algorithms to provide the user with a probability that John is a fraudster or if the item being sold is stolen, represented at 604. The assessment is provided to the user via an XML file 605 and can include a graphical representation of the neighborhood (fraud ring) of the individual, which can include bipartite core. The bipartite information can be pre-built providing a simple download of an XML file, minimizing chances of real-time computation of the bipartite core information. It is envisioned that one or more attributes can be utilized in providing a user with a probability that an individual is a fraudster or is selling stolen property. Such attributes are described in FIGS. 3, 4, and 5, but are not limited to such attributes. These attributes can be saved in a database or storage medium of all known attributes to uncover uniqueness or frequency of occurrence. In addition, these attributes can be compiled regardless of inconsistencies in formatting. In an aspect, e-commerce sales trends associated with merchandise types, categories, location can be compiled and presented to a user. Furthermore, a user can be alerted in advance or as occurring to theft patterns, crimes, and fraud rings based on compiled attributes, uploaded inventory lists, inventory adjustments, and/or location.

In an aspect, a user can administer the settings of the system, providing for personalized results or customization of the displayed material 606. For example, the user can review information contained on a specific web site, such as Ebay, or one or more web sites or platforms, such as Ebay, Craigslist, Amazon, Facebook, MySpace, etc. In addition, a user can specifically review information relating to one or more items being sold or that has been sold. Furthermore, a user can review specific attributes associated with an individual or item. For example, the user can review attributes, as described herein, associated with prior/current sales, USERID/Feedback, or item attributes in combination, separately, or in any other form. Furthermore, the systems and methods described herein can be utilized to print, export in any format such as excel or pdf any information or attribute described.

Aspects of the invention can be practice in multiple situations. For example, with respect to a web site such as Craigslist, the one or more attributes utilized in determining if an individual is involved in a fraud can include, but are not limited to, the attributes provided herein, phone numbers included in a posting, email addresses, web sites, titles of items sold, deviations in process, similarities in statements made in listing, names from listing, how many times a person listed or mentioned throughout the listings, items sold below cost and listed as brand new, high standard deviations in price as compared to similar other like items or sellers, high theft items, high value items, location of sale, and the location of the theft. In an aspect, the crawler utilized in retrieving these attributes can be able to select these attributes in non-consistent forms or without the ability to identify the information by html tags.

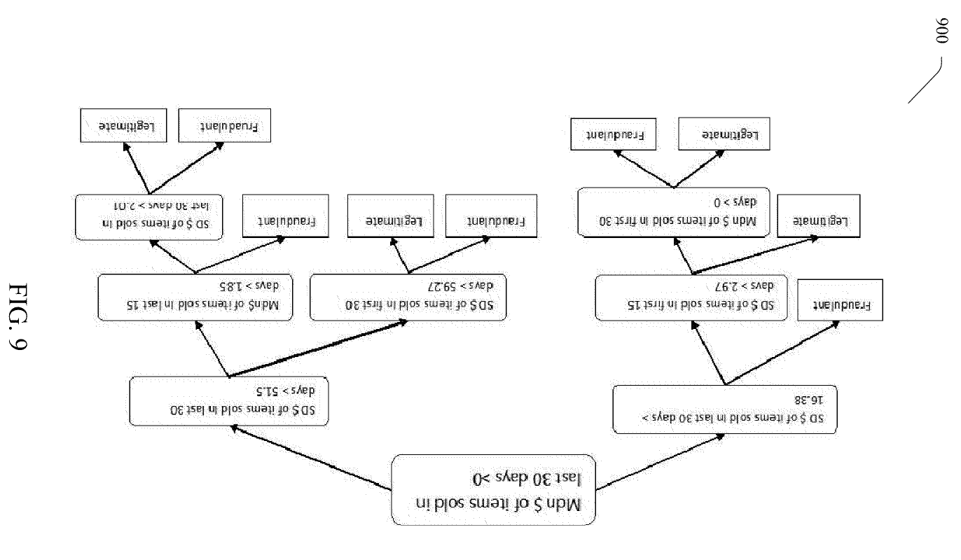

In addition, with respect to a web site such as Amazon, the one or more attributes utilized in determining if an individual is involved in a fraud can include, but are not limited to, the attributes provided herein, items sold below the lowest price available on Amazon, large standard deviations in price compared to similar sellers, free shipping or low shipping cost, high theft item, high value item, negative feedback , rating just launched, offering lower prices than like known sellers, USERID similar to other web sites, phone numbers included in a posting, email addresses, web sites, titles of items sold, deviations in process, similarities in statements made in listing, names from listing, how many times a person listed or mentioned throughout the listings, items sold below cost and listed as brand new, high standard deviations in price as compared to similar other like items or sellers, high theft items, high value items, location of sale, and the location of the theft. In an aspect, the crawler utilized in retrieving these attributes can be able to select these attributes in non-consistent forms or without the ability to identify the information by html tags. An example methodology of performing aspects of the invention is illustrated in FIG. 9.

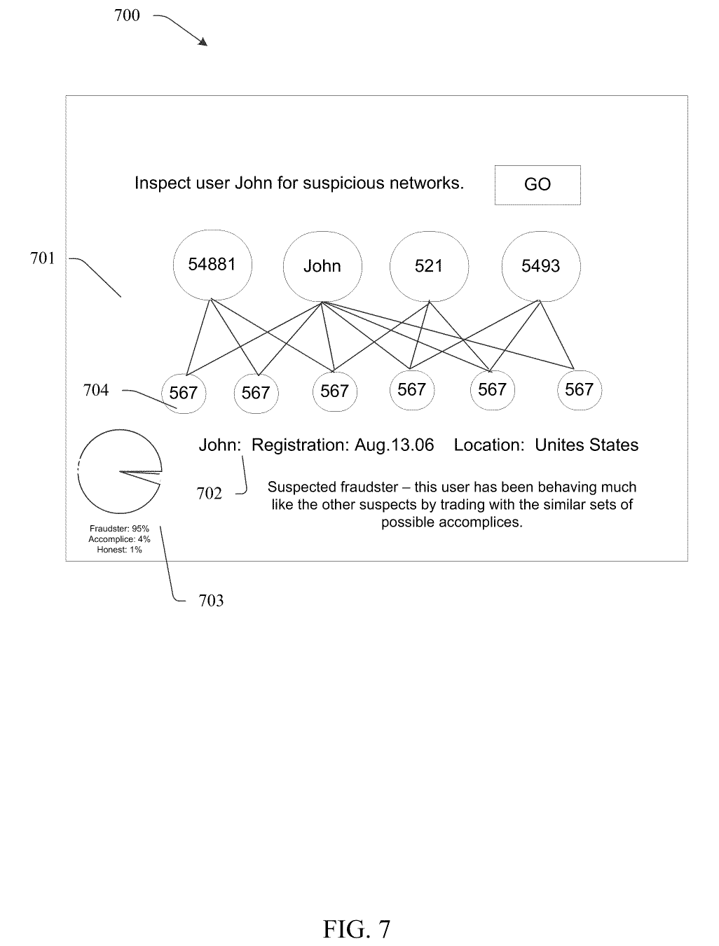

FIG. 7 illustrates a user interface in accordance with an aspect of the invention. As illustrated, the user interface, represented generally at 700, is based on a visualization of the graph neighborhood, represented generally at 701, for a user whose reputation is being queried 702. A visualization tool 703 can be utilized for users to understand the results that aspects of the present invention provide. The detected bipartite cores 704 explain to the user why the queried individual is being labeled as a fraudster, and also increase general awareness about the manner in which fraudsters operate. Users could combine the system's suggestions with their own judgment to assess the trustworthiness of an individual.

It is to be understood that aspects of the present invention can be utilized in conjunction with one or more social networks or other applications, such as Facebook, MySpace or Google Maps, to illustrate the associations of fraud or fraudsters with other users to determine the presence of fraud rings or to investigate probable fraud rings and associations. For example, a user can visualize the social network of the individual being investigated within one or more layers of networked friends. It is also envisioned that an employer can upload their business locations, inventory lists, inventory adjustments into the system for comparison of fraud or possible stolen items that have been identified utilizing the system and methods herein and then map these instances on Google maps to identify the location of the identified fraud, fraudster or fraud ring locations in comparison to the business location or losses. In addition, it is envisioned that an employer can upload employee information to determine if one or more employees is involved in a fraud.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the invention are possible. Accordingly, the disclosed subject matter is intended to embrace all such alterations, modifications and variations that fall within the spirit and scope of the appended claims. Furthermore, to the extent that the term “includes,” “has” or “having” or variations in the form thereof are used in either the detailed description or the claims, such terms are intended to be inclusive in a manner similar to the term “comprising” is interpreted when employed as a transitional word in a claim.

What is claimed is:

1. A method of detecting fraud, comprising:
receiving a user query relating to information associated with at least one of an individual and an item;
compiling one or more attributes provided on one or more web sites relating to at least one of the user query, the individual and the item;
determining a probability of fraud associated with at least one of the user query, the individual and the item; and
displaying information relating to the probability of fraud to the user.

2. The method of claim 1, where the information associated with the individual includes at least one of one or more USERIDs and usernames.

3. The method of claim 2, where the one or more attributes include information relating to at least one of the individual's sales history, the item's sales history, the individual's feedback and the item.

4. The method of claim 3, where determining the probability of fraud comprises calculating a correlation value based on a comparison of the item's sales history attributes as they relate to an item being sold.

5. The method of claim 4, where calculating the correlation value includes a determination of at least one of the median price of the item, the standard deviation of all like items, and the standard deviation of the same items.

6. The method of claim 5, where determining the probability of fraud further comprises performing a belief propagation relating to the individual and persons who have interacted therewith.

7. The method of claim 6, where determining the probability of fraud further comprises calculating a correlation value based on a comparison of the attributes of the item being sold and the attributes listed in one or more inventory lists, where the one or more inventory lists are uploaded by the user.

8. The method of claim 7, where the inventory lists contain information relating to at least one of an item's title, ISBN, location, loss date, and UPC.

9. The method of claim 8, where at least one of one or more attributes and correlation values are provided in XML format to the user.

10. The method of claim 9, further comprising providing for user customization of the displayed information.

11. The method of claim 10, where user customization includes at least one of selecting a web site to obtain attributes, selecting an item to obtain attributes, and selecting an individual to obtain attributes.

12. The method of claim 11, further comprising displaying a graphed neighborhood of the individual and mapping the user's location in relation to the graphed neighborhood.

13. The method of claim 12, where the graphed neighborhood is displayed utilizing information obtained from one or more social network web sites.

14. The method of claim 13, where the displayed information is provided on a web site.

15. A system for detecting fraud, the system comprising:
a computing device comprising memory for storing data in a data file, the memory storing a plurality of components comprising computer-executable instructions, the plurality of components including:
a receiving component for receiving a query relating to at least one of an individual and an item;
an attribute database component for obtaining and storing one or more attributes relating to at least one of one or more individuals, items, and the correlations thereof; and
an application server component for analyzing the correlations between the query and the attributes.

16. The system of claim 15, wherein the one or more attributes are obtained by one or more crawler agents.

17. The system of claim 16, wherein the one or more attributes are obtained through one or more auction-based web sites.

18. The system of claim 17, wherein the one or more attributes relate to at least one of the individual's USERID, username, and sales history.

19. The system of claim 17, further comprising a display component for displaying a report reviewable by a user relating to the query and the one or more attributes.

20. A computer-readable medium with computer-executable instructions to perform a method that comprises:
receiving a user query relating to information associated with at least one of an individual and an item;
compiling attributes provided on one or more web sites relating to at least one of the individual and the item;
determining a probability of fraudulent activities associated with at least one of the individual and the item;
alerting the user of fraudulent activities; and
displaying information relating to the probability of fraudulent activities to the user.
